(19) United States
(12) Patent Application Publication
(10) Pub. No.: US 2003/0168923 A1
(43) Pub. Date: Sep. 11, 2003

(54) Motor with magnetic attraction member

(75) Inventors: Masato Gomyo, Nagano (JP); Singo Suginobu, Nagano (JP)

Correspondence Address: HOGAN & HARTSON L.L.P., 500 S. GRAND AVENUE, SUITE 1900, LOS ANGELES, CA, 90071-2611, US

(73) Assignee: SANKYO SEIKI MFG. CO., LTD.

(21) Appl. No.: 10/379,390

(22) Filed: Mar. 4, 2003

(30) Foreign Application Priority Data
Mar. 8, 2002 (JP) 2002-064465
Mar. 14, 2002 (JP) 2002-070933

(51) Int. Cl. H02K 21/12

(52) U.S. Cl. 310/156.01

(57) ABSTRACT

A motor that can obtain a sufficient magnetic attraction force by a magnetic attraction member with a relatively simple and small structure is provided. The motor includes a stator section, a rotor section that is rotatably supported through a bearing section by the stator section, a rotor magnet disposed opposite to the stator core, and a magnetic attraction member that is disposed opposite to a circumferential wall surface of the rotor magnet in a radial direction to magnetically attract the rotor section toward the stator section by a magnetic action between the rotor magnet and the magnetic attraction member. The magnetic attraction member includes a generally cylindrical member that is disposed concentrically with the rotor magnet, wherein an outer circumferential wall surface of the generally cylindrical member of the magnetic attraction member is disposed opposite to an inner circumferential wall surface of the rotor magnet.

### BACKGROUND OF THE INVENTION

1. Field of the Invention

The present invention relates to a motor equipped with a magnetic attraction member that is effective to force a rotor section having a rotor magnet to be attracted to a stator section side through mutual magnetic attraction between the magnetic attraction member and the rotor magnet.

2. Related Background Art

A motor, such as a spindle motor, typically includes a stator section S that is composed of a stator core 1 having a plurality of salient poles and coils 2 wound on the respective salient poles and a rotor section R that is freely rotatably supported against the stator section S by a bearing section 3, as shown in FIG. 20. A rotor magnet 4 is provided on the rotor section R and disposed opposite to and in close proximity to outer circumferential end faces of the salient poles of the stator core 1.

In this motor, a magnetic attraction plate 5 that is made of a sheet of magnetic material is attached by an adhesive to a frame 6 on the side of the stator S in a manner to be opposed to an axial end face (a lower end face in the figure) of the rotor magnet 4 in an axial direction. The rotor section R is forced toward the stator section S by a magnetic attraction generated between the magnetic attraction plate 5 and the rotor magnet 4. The attraction force in the axial direction by the magnetic attraction plate 5 in the shape of a sheet may be used as a preliminary pressure in the axial direction for a thrust bearing or a pivot bearing, such that the rotor section R can be maintained in a stable rotational state.

However, the motor having the magnetic attraction plate 5 in the shape of a sheet is structured such that the magnetic attraction plate 5 is disposed in a manner overlapping the rotor magnet 4 in the axial direction; this structure causes to increase the thickness (height) of the motor in the axial direction, and there is a possibility that this structure is against the recent demands toward miniaturization of motors. To reduce the thickness of the motor in the axial direction, the magnetic attraction plate may be made thinner. As a result, however, the magnetic saturation may easily occur, and a sufficient magnetic attraction force may not be obtained. Also, the magnetic gap may be narrowed by reducing the distance between the rotor magnet and the magnetic attraction plate. However, this increase the influence of variations in assembly accuracy and parts accuracy, such that a stable magnetic attraction cannot be obtained; and as a result, higher accuracy is required and thus the manufacturing cost needs to be substantially increased. Such a lowered productivity poses an extremely serious problem in motors that have to use expensive material in order to achieve smaller size and obtain excellent characteristics.

In the meantime, in the motor described above, the magnetic attraction plate 5 of a limited size has to be disposed in a limited space. As a consequence, a thrust supporting force by the magnetic attraction plate 5 is limited, and a sufficient magnetic attraction force may not be obtained for the weight of the rotor body. In particular, in the case where a dynamic pressure bearing apparatus is used in the bearing section to levitate the rotor body in the thrust direction, when the weight of the rotor body increases as a result of an increased number of recording disks, for example, a magnetic attraction force greater than the weight of the rotor body may be needed depending on the orientation or posture of the motor, the thrust supporting force by the magnetic attraction plate 5 becomes insufficient, and the rotor body cannot be levitated always at the same location.

### SUMMARY OF THE INVENTION

The present invention relates to a motor that can obtain a sufficient magnetic attraction force through a magnetic attraction member with a relatively simple and small structure.

In accordance with an embodiment of the present invention, a motor includes a magnetic attraction member that is disposed opposite to a circumferential wall surface of a rotor magnet in a radial direction. In one aspect, the magnetic attraction member has a generally cylindrical member that is disposed concentrically with the rotor magnet.

The inventors of the present invention conducted various researches and studies about magnetic attraction forces that are obtained by magnetic attraction members. As a result, it was discovered that, if a magnetic attraction member that is disposed opposite to a rotor magnet in the radial direction is present, a magnetic attraction member that is disposed opposite to a rotor magnet in the axial direction like the conventional member has almost no influence on the magnetic attraction force. In other words, by using the motor having the novel structure of the present invention described above, the magnetic flux from the rotor magnet effectively functions as a magnetic attraction force by the magnetic attraction member, and the positional restriction of the rotor body in a thrust direction can be maintained well without regard to the orientation of the rotor body.

In the motor described above, the magnetic attraction member has a mounting section for mounting the magnetic attraction member on the stator section, wherein the mounting section may extend in the radial direction in a flat plate shape in a direction away from the rotor magnet. As a result, the magnetic attraction member can be readily and securely disposed and mounted on the stator section through the mounting section without being obstructed by the rotor magnet.

In the motor described above, the magnetic attraction member has a mounting section for mounting the magnetic attraction member on the stator section, wherein the mounting section may include radially extending members that extend in core slots between a plurality of salient poles of the stator core on which coils are wound. As a result, even when the stator core and the mounting section are disposed adjacent to each other in the axial direction, the length of the mounting section in the radial direction can be made longer, such that the motor can be reduced in size and the mounting rigidity of the magnetic attraction member can be improved.

In the motor described above, the magnetic attraction member may include a mounting section and a bent section that connects in one piece to the mounting section, wherein the bent section is abutted against a stepped section formed in the stator section to position the magnetic attraction member. As a result, the magnetic attraction member can be mounted on the stator section with a high accuracy, such that a stable motor characteristic can be obtained at low costs.

In the motor described above, the magnetic attraction member may be formed in one piece with the stator section with a molding resin into a core molded component. As a result, the magnetic attraction member can be readily assembled with a high accuracy.

In the motor described above, the magnetic attraction member may include an axial direction opposing section that is disposed opposite to an axial direction end face of the rotor magnet in the axial direction. In this case, a magnetic action generated at the opposing sections in the axial direction is added to a magnetic action caused by the generally cylindrical member that is disposed opposite to the circumferential wall surface of the rotor magnet in the radial direction. As a result, the magnetic flux from the rotor magnet can be effectively used as a magnetic attraction force.

Also, in accordance with another embodiment of the present invention, a motor includes a magnetic attraction plate that extends in a direction generally perpendicular to an axial direction, wherein the magnetic attraction plate includes an axial direction opposing section that is opposite to a rotor magnet in an axial direction, and a radial direction opposing section that bends generally at right angle from the axial direction opposing section and extends generally in the axial direction and is opposite to the rotor magnet in a radial direction.

With the motor having such a structure, the magnetic flux from the rotor magnet can be effectively used as the magnetic attraction force through both of the axial direction opposing section and the radial direction opposing section of the magnetic attraction plate, and the positional restriction on the rotor body in the thrust direction is maintained well without regard to the posture or orientation of the rotor body.

In the motor described above, the radial direction opposing section of the magnetic attraction plate may be disposed opposite to an inner circumferential wall surface or an outer circumferential wall surface of the rotor magnet. As a result, the radial direction opposing section can be readily formed by, for example, bending a part of the axial direction opposing section.

In the motor described above, the bearing section may be composed of a dynamic pressure bearing section that uses dynamic pressure of lubrication fluid. As a result, the support of the rotor body in the thrust direction can be improved.

In the motor described above, the radial direction opposing section of the magnetic attraction plate may have magnetic attraction plate segments that enter slot sections between salient poles of the stator core. As a result, the radial direction opposing section can function as a yoke for reducing cogging.

In the motor described above, the radial direction opposing section of the magnetic attraction plate may be formed in one piece with the stator core with a molding resin to define an integrated core product. As a result, the magnetic attraction plate can be readily assembled.

Other objects, features and advantages of the invention will become apparent from the following detailed description taken in conjunction with the accompanying drawings.

### BRIEF DESCRIPTION OF THE DRAWINGS

FIG. 1 schematically shows a longitudinal cross section of a shaft rotation-type HDD motor in accordance with an embodiment of the present invention.

FIG. 2 schematically shows in longitudinal cross sections a process of manufacturing a magnetic attraction member used in the HDD motor shown in FIG. 1.

FIG. 3 schematically shows in cross sections a magnetic attraction member having an exemplary structure in states in which the magnetic attraction member is gradually separated in an axial direction from a rotor magnet.

FIG. 4 shows a graph indicating changes in the magnetic attraction force when the magnetic attraction member is gradually separated in an axial direction from the rotor magnet according to FIG. 3.

FIG. 5 schematically shows a longitudinal cross section of a HDD motor in accordance with another embodiment of the present invention.

FIG. 6 schematically shows a longitudinal cross section of a HDD motor in accordance with still another embodiment of the present invention.

FIG. 7 schematically shows a plan view of a stator section of the HDD motor shown in FIG. 6.

FIG. 8 schematically shows a longitudinal cross section of a HDD motor in accordance with still another embodiment of the present invention.

FIG. 9 schematically shows a longitudinal cross section of a HDD motor in accordance with still another embodiment of the present invention.

FIG. 10 schematically shows a longitudinal cross section of a shaft rotation-type HDD spindle motor equipped with a dynamic pressure bearing section in accordance with an embodiment of the present invention.

FIG. 11 schematically shows an enlarged longitudinal cross section of main parts of the HDD spindle motor shown in FIG. 10.

FIG. 12 schematically shows an enlarged longitudinal cross section of a conventional magnetic attraction plate.

FIG. 13 shows a graph comparing magnetic attraction forces generated by the magnetic attraction plate shown in FIG. 11 and magnetic attraction forces generated by the magnetic attraction plate shown in FIG. 12.

FIG. 14 shows a graph indicating changes in the magnetic attraction force when an axial direction opposing section of the magnetic attraction member shown in FIG. 11 is gradually separated in an axial direction from the rotor magnet.

FIG. 15 schematically shows a longitudinal cross section of a HDD spindle motor in accordance with another embodiment of the present invention.

FIG. 16 schematically shows a longitudinal cross section of a HDD spindle motor in accordance with still another embodiment of the present invention.

FIG. 17 schematically shows a longitudinal cross section of a HDD spindle motor in accordance with still another embodiment of the present invention.

FIG. 18 shows a plan view indicating positional relations between a stator core used in the spindle motor and a magnetic attraction plate shown in FIG. 17.

FIG. 19 schematically shows a longitudinal cross section of a HDD spindle motor in accordance with still another embodiment of the present invention.

FIG. 20 schematically shows a longitudinal cross section of a conventional shaft rotation-type HDD spindle motor equipped with a dynamic pressure bearing section.

### DESCRIPTION OF PREFERRED EMBODIMENTS

A hard disk driving apparatus (HDD) that uses a dynamic pressure bearing apparatus is described below with reference to the accompanying drawings as an example of a motor in accordance with an embodiment of the present invention.

First, an embodiment that can miniaturize motors is described. In this embodiment, a motor has a magnetic attraction member disposed in a manner not to oppose a rotor magnet in an axial direction of the motor.

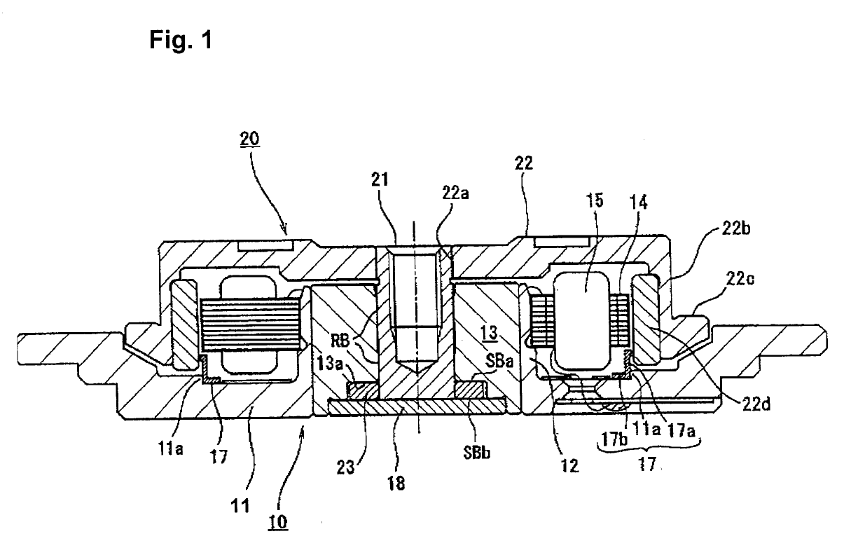

A shaft rotation-type HDD spindle motor shown in FIG. 1 uses a dynamic pressure bearing apparatus. The motor is generally formed from a stator section 10 as a fixed member, and a rotor section 20 as a rotor member that is assembled from above (in the figure) the stator section 10. The stator section 10 includes a fixed frame 11 that may be affixed to a fixed table (not shown) by screws or the like. The fixed frame 11 may be formed from an aluminum metal material to achieve a lighter weight. The fixed frame 11 includes a circular bearing holder 12 that extends upwardly (in the figure) generally in a central section of the fixed frame 11. A bearing sleeve 13 as a fixed bearing member in a hollow cylindrical configuration is inserted in the bearing holder 12 and connected to an inner circumferential wall surface of the bearing holder 12 through press fitting or shrink fitting. The bearing sleeve 13 may be formed from a copper material such as phosphor bronze to facilitate machining holes with small diameters.

A stator core 14, which consists of a laminate of electromagnetic steel plates, is mounted on the outer circumference mounting surface of the bearing holder 12, and drive coils 15 are wound on a plurality of salient pole sections on the stator core 14, in which the plurality of salient pole sections may radially outwardly extend in a radial direction.

A rotary shaft 21 that comprises the rotor assembly 20 is inserted in a center hole provided in the bearing sleeve 13 in a freely rotatable manner. More specifically, a dynamic pressure surface formed on an inner circumference wall section of the bearing sleeve 13 and a dynamic pressure surface formed on an outer circumference surface of the rotary shaft 21 are positioned opposite to each other in the radial direction, and two radial dynamic pressure bearing sections RB and RB are formed in minuscule gap sections between them with an appropriate interval between the two radial dynamic pressure bearing sections RB and RB in the axial direction. More specifically, the dynamic pressure surface on the bearing sleeve 13 side and the dynamic pressure surface on the rotary shaft 21 side of each of the radial dynamic pressure bearing sections RB are positioned opposite to each other in a circular fashion across a minuscule gap of several μm, and a lubricating fluid such as a lubricating oil, magnetic fluid or air is filled or present in a continuous manner in the axial direction in a bearing space formed by the minuscule gap.

On at least one of the dynamic pressure surfaces of the bearing sleeve 13 and the rotary shaft 21 is provided herringbone-shaped radial dynamic pressure generating grooves, for example, that are concavely formed in a ring shape in two blocks separated in the axial direction. During rotation, a pumping effect of the radial dynamic pressure generating grooves pressurizes the lubricating fluid, which is omitted from drawings, to generate dynamic pressure, and a rotary hub 22, which is described later, together with the rotary shaft 21 become shaft-supported in the radial direction in a non-contact state with the bearing sleeve 13 due to the dynamic pressure of the lubricating fluid.

The rotary hub 22 that with the rotary shaft 21 comprises the rotor assembly 20 is a generally cup-shaped member made of a ferrite stainless steel, and a joining hole 22a provided in the center part of the rotary hub 22 is joined in a unitary fashion with the top end part of the rotary shaft 21 through press fitting or shrink fitting. The rotary hub 22 has a body section 22b, which is generally in a cylindrical shape and serves to mount a recording medium disk such as a magnetic disk omitted from drawings on its outer circumference section, as well as a disk mounting section 22c, which projects outward in the radial direction from the body section 22b to support the recording medium disk in the axial direction. A recording medium disk may be fixed by a pressure applied from above (in the drawing) with a damper (omitted from drawings) that is screwed on from above.

On the inner circumference wall surface of the body section 22b of the rotary hub 22 is mounted a ring-shaped drive magnet 22d. The ring-shaped drive magnet 22d is positioned in a circle and disposed in close proximity to and opposite to the outer circumference end surfaces of the salient poles of the stator core 14.

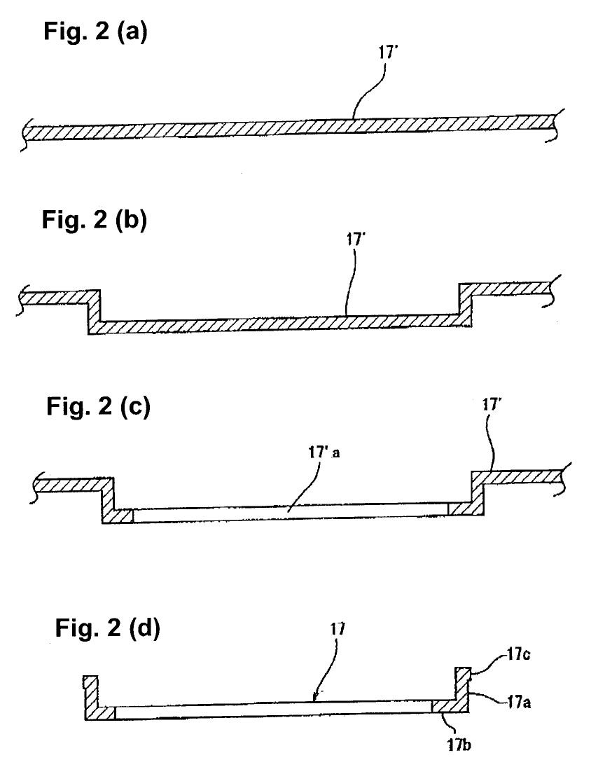

A magnetic attraction member 17 is attached to a surface of the fixed frame 11 at a position immediately blow a lower end face (in the figure) of the rotor magnet 22d, in other words, immediately below an end face of the rotor magnet 22d that faces the fixed frame 11 side. The magnetic attraction member 17 may be fabricated by press-forming a magnetic member such as iron material. The magnetic attraction member 17 may be formed into generally a hollow cylindrical configuration as indicated in FIG. 2(d), and has a flange-like standing wall section 17a located at an outermost circumference of the hollow cylindrical configuration. The standing wall section 17a is disposed opposite and in close proximity in the radial direction to the inner circumferential wall surface of the rotor magnet 22d. The standing wall section 17a may extend above the lower end surface of the rotor magnet 22d.

An outer circumferential surface of the flange-like standing wall section 17 at its lower end side is abutted from inside against a standing wall surface of a step section 11a provided in the fixed frame 11. As a result, the magnetic attraction member 17 can be highly accurately positioned in the radial direction by the positional restriction action of the stepped section 11a.

The standing wall section 17a may include a mounting section 17b in the form of a plate and a bent section that bents generally at right angle with respect to the standing wall section and connects to the mounting section 17b in a unitary fashion. The mounting section 17b extends inward from the lower end section of the standing wall section 17a, in other words, extends inward in a direction away from the rotor magnet 22d, and a lower surface of the mounting section 17b is affixed to an upwardly facing surface (in the figure) of the fixed frame 11 by a fixing means such as adhesive.

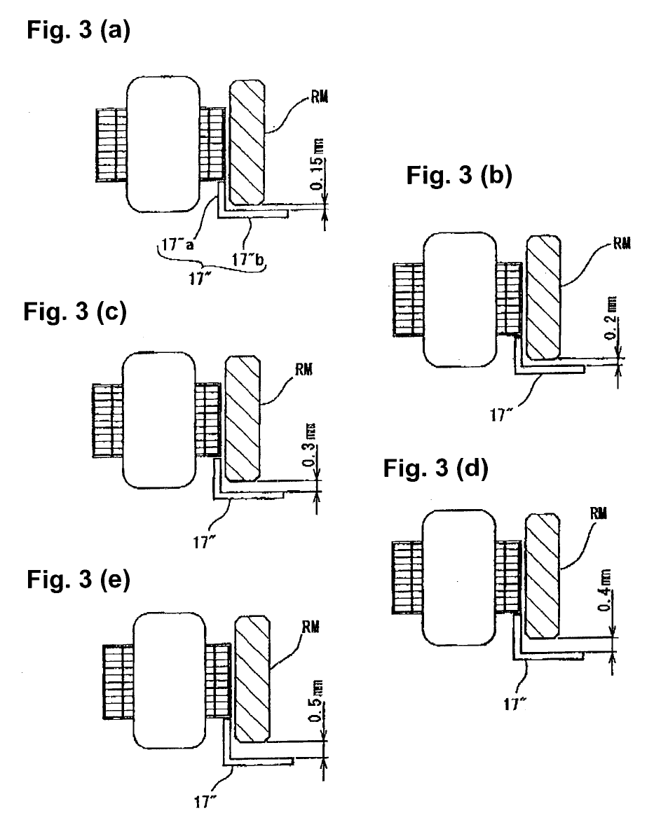

The magnetic attraction member 17 in accordance with the present embodiment may be formed with a press-formed component of magnetic material, and may be fabricated by a method indicated in FIGS. 2(a)-2(d). First, a plate shaped material 17′ is prepared as indicated in FIG. 2(a). The plate shaped material 17′ is drawing-pressed from above (in the figure) to be formed into a cup shape, as indicated in FIG. 2(b). Then, a hole 17′a having a specified size is punched through a bottom section of the cup shape by a punch-press, as indicated in FIG. 2(c). Then, the material 17′ is cut in a circular shape with its outer circumference having a specified size, to obtain a generally cylindrical magnetic attraction member 17, as indicated in FIG. 3(d).

As shown in FIG. 2(d), a burr 17c may be left at the outer circumference of the material 17a when the material 17′ is cut along the outer circumference of the member 17. However, the burr 17c may be completely removed. Alternatively, the burr 17c may be positively left as an opposing protrusion with respect to the magnet. The opposing protrusion 17c may be positioned close to the magnet such that the magnetic flux can be readily converged.

In FIG. 1, a disk-shaped thrust plate 23 is affixed to one end section (the lower end side in the figure) of the rotor shaft 21 through shrink-fitting or press-fitting. The thrust plate 23 is received in a cylindrical recessed section 13a formed in a central section of the bearing sleeve at its lower end side. A dynamic pressure surface is provided on a top surface (in the figure) of the thrust plate 23, and a dynamic pressure surface is provided on a bottom surface (in the figure) of the cylindrical recessed section 13a of the bearing sleeve 13. The dynamic pressure surface of the thrust plate 23 and the dynamic pressure surface of the recessed section 13a of the bearing sleeve 13 are positioned in close proximity to and opposite to each other in the axial direction across a minuscule gap of several μm. Herringbone-shaped thrust dynamic pressure generating grooves (not shown) are formed on the dynamic pressure surface of the thrust plate 23, such that an upper thrust dynamic pressure bearing section SBa is formed at opposing sections of the thrust dynamic pressure surfaces of the thrust plate 23 and the bearing sleeve 13.

A counter plate 18, which is formed from a circular disk plate of a relatively large diameter, is disposed in proximity to a dynamic pressure surface of the thrust plate 23 on a lower side thereof. The counter plate 18 is disposed in a manner to close a lower end side opening of the bearing sleeve 13, and an outer circumferential portion of the counter plate 18 is affixed to the bearing sleeve 13 by an appropriate means such as calking. Herringbone-shaped thrust dynamic pressure generating grooves (not shown) are formed on the lower dynamic pressure surface of the thrust plate 23, whereby a lower thrust dynamic pressure bearing section SBb is formed.

The dynamic pressure surfaces of the thrust plate 23 and the corresponding opposing dynamic pressure surfaces of the bearing sleeve 13 and the counter plate 18, which compose a pair of the thrust dynamic pressure bearing sections SBa and SBb disposed adjacent to each other in the axial direction, are positioned opposite to each other in the axial direction across a minuscule gap of several μm; and a lubricating fluid such as oil, magnetic fluid or air is present or filled continuously in the axial direction through an outer circumferential passage provided in the thrust plate 23 into the bearing space comprising the minuscule gap. During rotation, a pumping effect of the thrust dynamic pressure generating grooves provided on the thrust plate 23 pressurizes the lubricating fluid to generate dynamic pressure; and the dynamic pressure of the lubricating fluid causes the rotary shaft 21 and the rotary hub 22 to be supported levitating in the thrust direction and in a noncontact manner.

With the motor having the magnetic attraction member 17 described above in accordance with the present embodiment, the magnetic flux from the rotor magnet 22d can be effectively used as the magnetic attraction force by the magnetic attraction member 17, and the positional restriction on the rotor body in the thrust direction is maintained well without regard to the posture or orientation of the rotor body.

As a result of various researches and studies conducted by the present inventors about magnetic attraction forces that are obtained by the magnetic attraction member 17, it was discovered that, if a member that is disposed opposite to the rotor magnet 22d in the radial direction, for example, the standing wall section 17a of the magnetic attraction member 17, is present, a sufficient magnetic attraction force can be obtained.

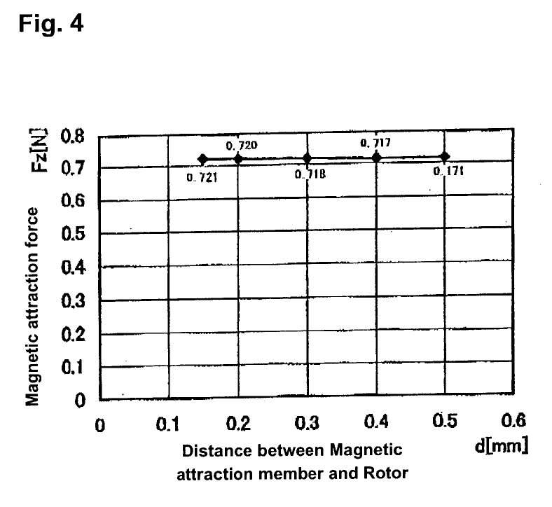

For example, in one experiment conducted, as indicated in FIGS. 3(a)-3(e), a magnetic attraction member 17″, which is disposed adjacent to a rotor magnet RM, is formed from a radial direction opposing section 17″a and an axial direction opposing section 17″b. While the length of the radial direction opposing section 17″a of the magnetic attraction member 17″ that is opposite to the magnet is kept constant, the position of the axial direction opposing section 17″b is successively changed in the axial direction as indicated in FIGS. 3(a) to 3(e) to change the distance between the axial direction opposing section 17″b and the rotor magnet RM. As a result, it was discovered that the magnetic attraction force (along a vertical axis) caused by the entire magnetic attraction member 17″ in the axial direction shows almost no change with respect to changes in the distance between the rotor magnet RM and the axial direction opposing section 17″b (along a horizontal axis), as indicated in FIG. 4.

From this experiment, it is understood that a required magnetic attraction action can be effectively obtained by using the magnetic attraction member 17 opposing to the rotor magnet in the radial direction.

Also, in the motor in accordance with the present embodiment, the mounting section 17b in a plate shape that is provided at the magnetic attraction member 17 extends inwardly in a direction away from the rotor magnet 22d, such that the magnetic attraction member 17 can be readily and securely mounted without being obstructed by the rotor magnet 22d. Also, the mounting section 17b is connected to the standing wall section 17a in a unitary fashion through the bent section. The magnetic attraction member 17 having such a structure can be effectively fabricated by a relatively simple bend forming such as press working.

Moreover, the standing wall section 17a of the magnetic attraction member 17 is abutted against the step section 11a of the fixed frame 11 to position itself in the radial direction. As a result, the magnetic attraction member 17 can be mounted with a high precision, and therefore a stable motor characteristic can be obtained.

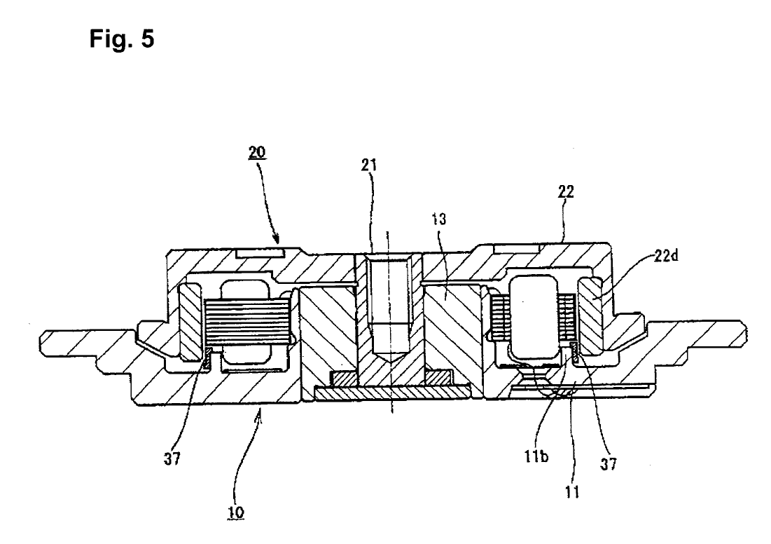

FIG. 5 shows a motor in accordance with another embodiment of the present invention. In this embodiment, the same components as those of the embodiment described above are assigned the same reference numbers. A circular protrusion 11b having a convex cross section is disposed inside and concentrically with the rotor magnet 22d. The circular protrusion 11b protrudes upwardly (in the figure) from the surface of the fixed frame 11. A magnetic attraction member 37 that is formed in a ring shape and protruded in a different direction is attached to an outer circumferential side of the circular protrusion 11b. The magnetic attraction member 37 may be fitted from above (in the figure) over the circular protrusion 11b. An outer circumferential wall surface of the magnetic attraction member 37 is disposed in close proximity and opposite to an inner circumferential wall surface of the rotor magnet 22d in the radial direction. This embodiment also provides actions and effects similar to those of the aforementioned embodiment.

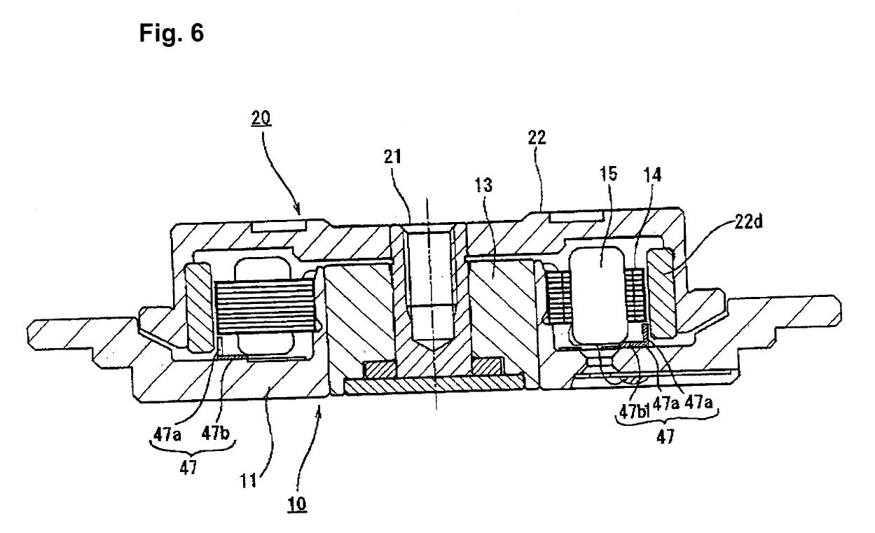

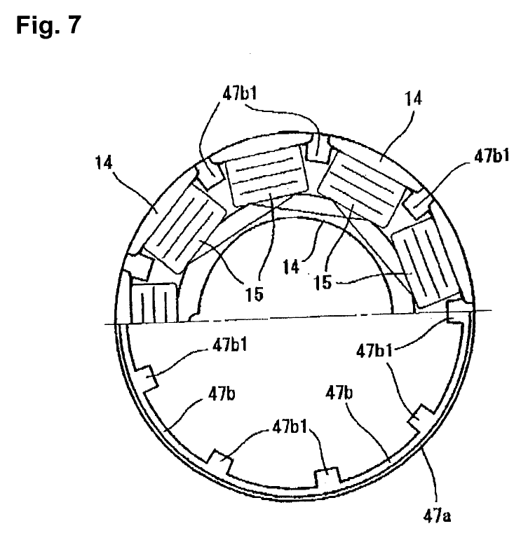

FIGS. 6 and 7 show a motor in accordance with still another embodiment of the present invention. In this embodiment, the same components as those of the embodiment described above are assigned the same reference numbers. A magnetic attraction member 47 includes a flange-like standing wall section 47a and a mounting section 47b that extends inwardly. The flange-like standing wall section 47a is disposed opposite to the inner circumferential wall surface of the rotor magnet 22d in the radial direction, and the mounting section 47b is provided at a lower end section (in the figure) of the flange-like standing wall section 47a. In particular, in the present embodiment, the mounting section 47b is provided at its inner circumferential section with a plurality of inwardly protruding sections 47b 1 arranged in a circumferential direction at generally equal pitches. The inwardly protruding sections 47b 1 are arranged to protrude in the radial direction toward a center of the rotor magnet 22d.

The inwardly protruding sections 47b 1 are disposed to extend in core slots between the salient poles of the stator core 14 on which the coils 15 are wound. Therefore, each of the inwardly protruding sections 47b 1 of the mounting section 47b extends into a space defined between adjacent ones of the coils 15. In the present embodiment, each of the inwardly protruding sections 47b 1 of the mounting section 47b is positioned to be lapped in each of the spaces between the coils 15 in the axial direction.

By this embodiment, in addition to the actions and effects provided by each of the aforementioned embodiments, since each of the inwardly protruding sections 47b 1 of the mounting section 47b of the magnetic attraction member 47 is composed in a manner to be lapped in each of the spaces between the coils 15 in the axial direction, the entire motor can be made thinner in the axial direction accordingly. Also, the mounting section 47b can be provided with a relatively great length in the radial direction, whereby the motor can be further reduced in size and the mounting rigidity of the magnetic attraction member 47 is improved.

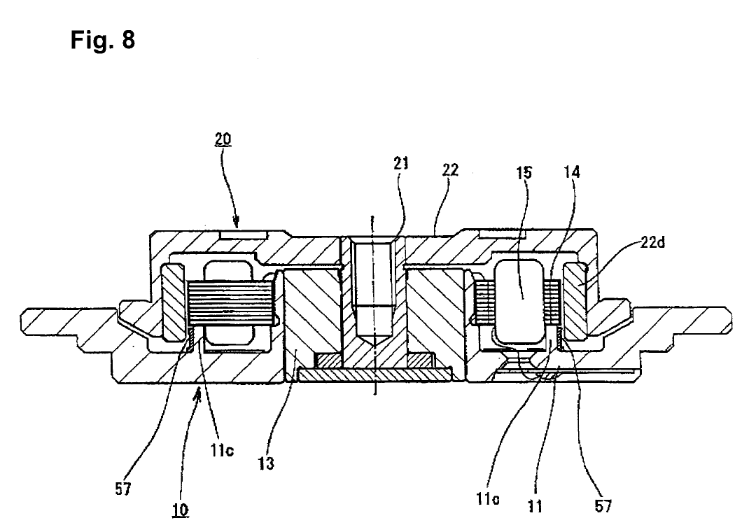

FIG. 8 shows a motor in accordance with still another embodiment of the present invention. The embodiment shown in FIG. 8 has a structure similar to the embodiment shown in FIG. 5. More specifically, a circular protrusion 11c is disposed inside and concentrically with the rotor magnet 22d. The circular protrusion 11c protrudes upwardly (in the figure) from the surface of the fixed frame 11. A magnetic attraction member 57 that is formed in a generally cylindrical form is attached to an outer circumferential side of the circular protrusion 11c. The magnetic attraction member 57 may be fitted from above (in the figure) over the circular protrusion 11c. An outer circumferential wall surface of the magnetic attraction member 57 is disposed in close proximity and opposite to an inner circumferential wall surface of the rotor magnet 22d in the radial direction.

In the embodiment shown in FIG. 8, an end surface on the protruded side (the upper end side in the figure) of the circular protrusion 11c is formed as a supporting surface to support the stator core 14. The stator core 14 is rests in the axial direction on the supporting surface circular protrusion 11c, which are affixed together by an adhesive or the like.

In addition to the actions and effects provided by each of the aforementioned embodiments, in accordance with the embodiment shown in FIG. 8, the stator core 14 is highly accurately and strongly retained in position. In particular, the holding height of the stator core 14 can be stably obtained, and therefore the magnetic attraction force between the rotor magnet 22d and the stator core 14 is stabilized better.

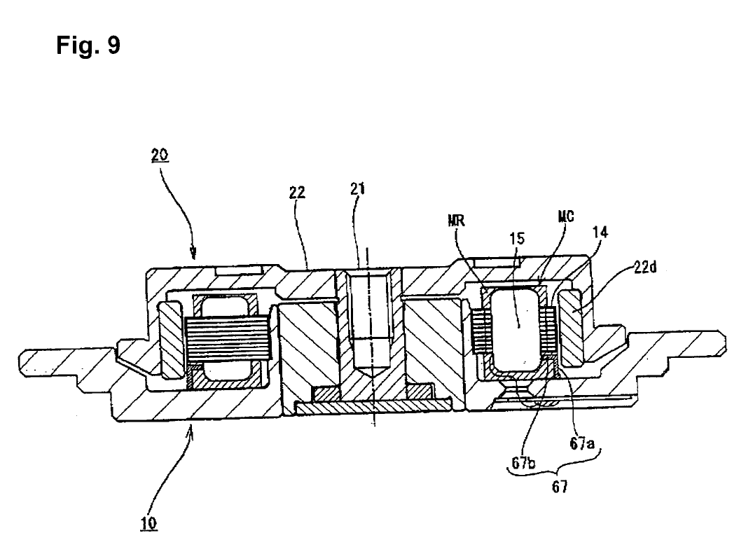

FIG. 9 shows a motor in accordance with still another embodiment of the present invention. A magnetic attraction member 67 that is disposed opposite to the rotor magnet 22d in the radial direction includes a mounting section 67b that extends inwardly in the radial direction. In this embodiment, the mounting section 67b is formed with the stator core 14 on which the coils 15 are wound (i.e., a core winding assembly) in one piece with a mold forming resin MR such as liquid crystal polymer, which composes a unitary core molded component MC. The core molded component MC may be fabricated by an insert forming, for example, and the core molded component MC after being insert-formed is attached to the fixed frame 11.

In addition to the actions and effects provided by each of the aforementioned embodiments, in accordance with the embodiment shown in FIG. 9, the core winding assembly including the stator core 14 and the magnetic attraction member 67 are highly accurately positioned with each other coaxially and in the height direction within the forming metal mold, which provides good motor characteristics.

In the embodiments described above, each of the magnetic attraction members has a structure that does not oppose the rotor magnet in the axial direction. However, the mounting section 17b of each of the magnetic attraction members may be formed on the side that may oppose the rotor magnet in the axial direction. In this case, a major part of the effects of the aforementioned embodiments can also be obtained.

Next, in accordance with another embodiment of the present invention, a motor has a structure that can obtain a sufficient magnetic attraction force with respect to a rotor body although a magnetic attraction member is disposed opposite to a rotor magnet in the axial direction.

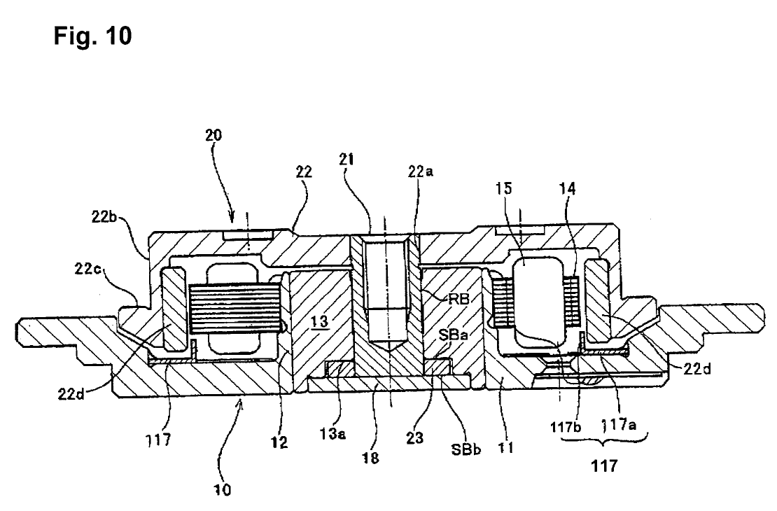

FIG. 10 shows a shaft-rotating type HDD spindle motor. The structure of the motor except its magnetic attraction plate and the structure of the bearing are the same as those of the embodiment shown in FIG. 1. Therefore the structure of the magnetic attraction plate is mainly described.

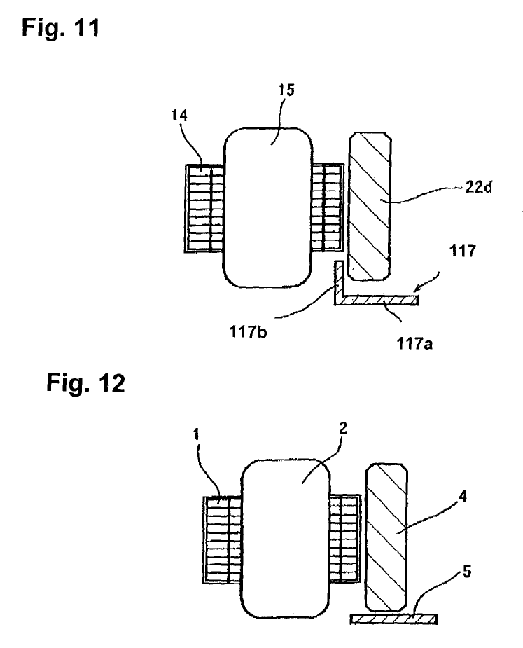

A lower end surface of the rotor magnet 22d opposes the fixed frame 11, and a sheet-like magnetic attraction plate 117, which may be formed from a magnetic member such as iron material, is attached to a surface of the fixed frame 11 immediately below the lower end surface of the rotor magnet 22d. As shown in FIG. 11, the magnetic attraction plate 117 includes an axial direction opposing section 117a that may be in a plane ring shape and directly attached to the surface of the fixed frame 11 by an appropriate means such as adhesive. The axial direction opposing section 117a extends in a direction generally perpendicular to the axial direction, and is disposed opposite to the lower end face of the rotor magnet 22d in the axial direction.

A radial direction opposing section 117b extends in the axial direction generally at right angle from the axial direction opposing section 117a at an inner end edge in the radial direction of the axial direction opposing section 117a. The radial direction opposing section 117b thus extends in the form of a circular standing wall. The axial direction opposing section 117a is disposed opposite to an inner circumferential wall surface of the rotor magnet 22d through an appropriate gap in the radial direction provided in between.

With the spindle motor equipped with the magnetic attraction plate 117 in accordance with the present embodiment, the magnetic flux from the rotor magnet 22d effectively functions through both of the axial direction opposing section 117a and the radial direction opposing section 117b of the magnetic attraction plate 17, whereby the positional restriction of the entire rotor body including the rotor hub 22 and rotor shaft 21 can be well maintained without regard to the posture or orientation of the rotor body.

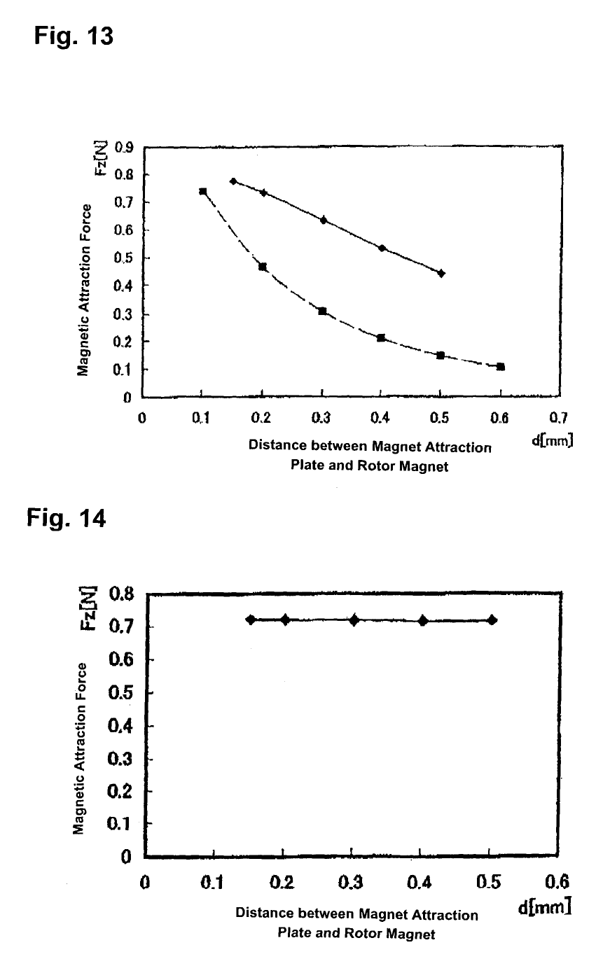

For example, when a conventional magnetic attraction plate in a plane sheet shape shown in FIG. 12 is used, and as the magnetic attraction plate 5 is gradually separated from the rotor magnet 4 in the axial direction such that the opposing distance d (along the horizontal axis in the graph in FIG. 13) between the two members, the magnetic attraction force (along the vertical axis in the graph in FIG. 13) between the two members tends to rapidly decrease, as indicated by a broken line in FIG. 13.

In contrast, when the magnetic attraction plate 117 in the present embodiment is used, the magnetic attraction plate obtained by the use of the magnetic attraction plate 117 is generally greater than that obtained by the conventional magnetic attraction plate at the same axial direction distance. Furthermore, even when the magnetic attraction plate 117 is gradually separated from the rotor magnet 4 in the axial direction, the degree of reduction (slope) in the magnetic attraction force is smaller. It is understood from the above that, in accordance with the present embodiment, the magnetic flux between the rotor magnet 22d and the magnetic attraction plate 17 is effectively utilized.

When the position of the upper end of the radial direction opposing section 117b of the magnetic attraction plate 117 is kept at the same location, and only the axial direction opposing section 117a is shifted in the axial direction (for example, by changing the length of the radial direction opposing section 117b) to change the distance between the axial direction opposing section 117a and the rotor magnet 22d, the magnetic attraction force (along a vertical axis of the graph) in the axial direction by the magnetic attraction plate 117 shows almost no change with respect to changes in the distance (along a horizontal axis of the graph) between the rotor magnet 22d and the axial direction opposing section 117a, as shown in FIG. 14. It is also understood from the above that the magnetic attraction effect of the radial direction opposing section 117b of the present embodiment is functioning well.

In addition to the above, in the spindle motor of the present embodiment, the radial direction opposing section 117b of the magnetic attraction plate 117 is disposed opposite to the inner circumferential wall surface of the rotor magnet 22d. As a result, the radial direction opposing section 117b can be readily formed by an appropriate method, such as, by bending a part of the magnetic attraction plate 117 with respect to the axial direction opposing section 117a.

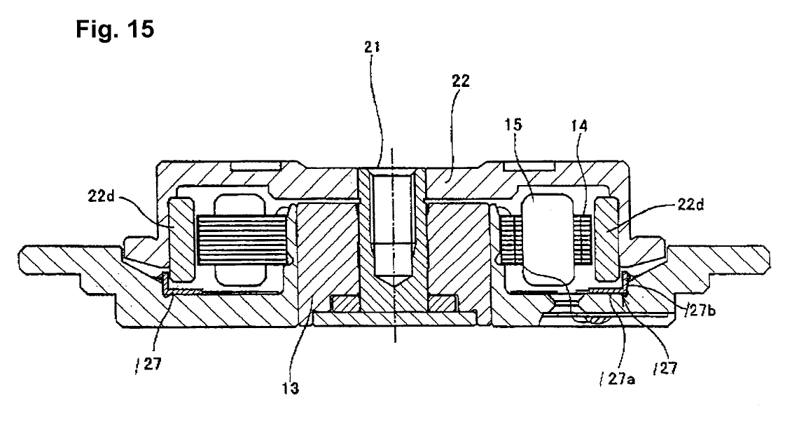

FIG. 15 shows a motor in accordance with another embodiment of the present invention. The motor includes a magnetic attraction plate 127 having an axial direction opposing section 127a and a radial direction opposing section 127b that bends generally at right angle from the axial direction opposing section 127a and extends upwardly. The radial direction opposing section 127b is disposed radially outside and opposite to an outer circumferential wall surface of a rotor magnet 22d.

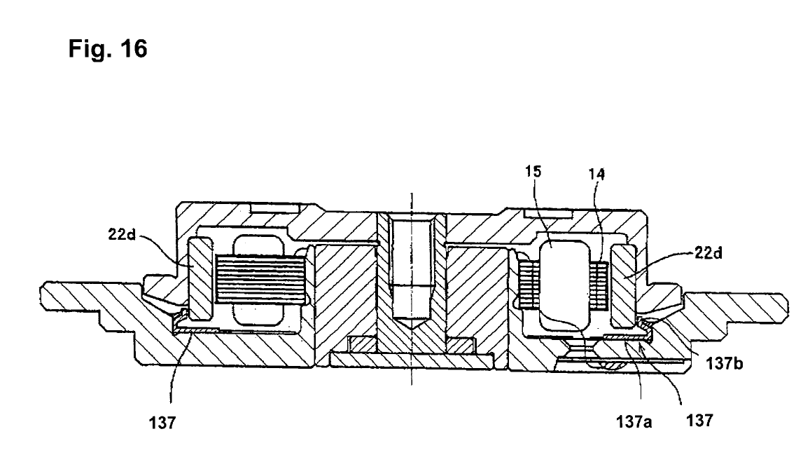

FIG. 16 shows a motor in accordance with another embodiment of the present invention. The motor includes a magnetic attraction plate 137 having a radial direction opposing section 137b that is disposed on the outer circumferential side of a rotor magnet 22d. The radial direction opposing section 137b is bent in the magnetic attraction plate 137 to have a slanted wall section that extends from the fixed frame 11 toward the outer circumferential wall surface of the rotor magnet 22d. The slanted wall section of the radial direction opposing section 137b includes an axial direction extended section at its end, which is disposed in close proximity and opposite to the outer circumferential wall surface of the rotor magnet 22d. Each of the embodiments shown in FIGS. 15 and 16 also provides the same actions and effects provided by the embodiment shown in FIG. 10.

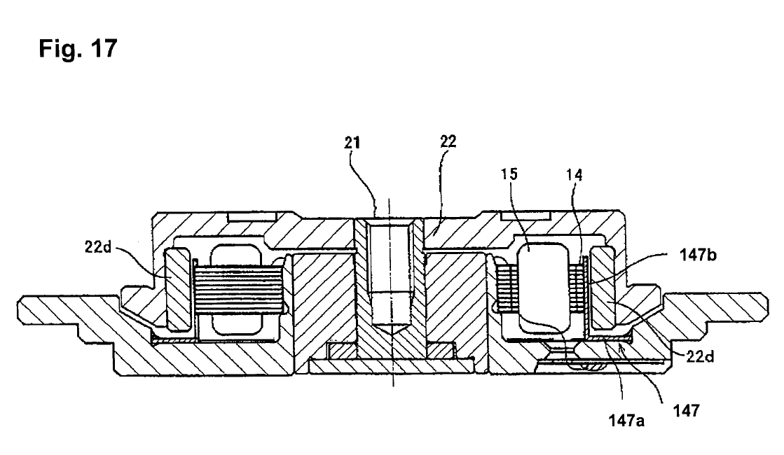

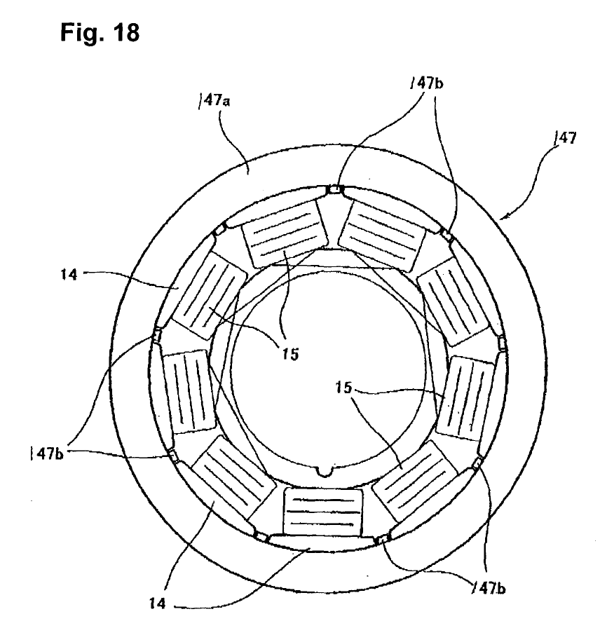

Also, FIGS. 17 and 18 show a motor in accordance with still another embodiment of the present invention. The motor includes a magnetic attraction plate 147 having an axial direction opposing section 147a and a radial direction opposing section 147b that is bent generally at right angle and extends upwardly from the axial direction opposing section 147a. The radial direction opposing section 147b is formed in the shape of a comb teeth. The plural comb teeth sections of the radial direction opposing section 147b are arranged in a circumferential direction at appropriate intervals. The plural comb teeth sections of the radial direction opposing section 147b are disposed to enter slot sections S formed between the plural salient poles, respectively, as shown in FIG. 18.

By the embodiment having such a structure, the radial direction opposing section 147b can be functioned as a yoke for reducing cogging, whereby the rotation characteristic of the motor is improved.

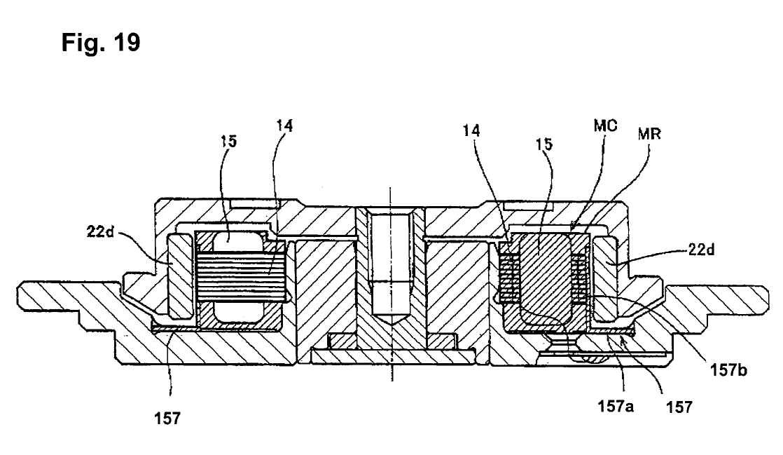

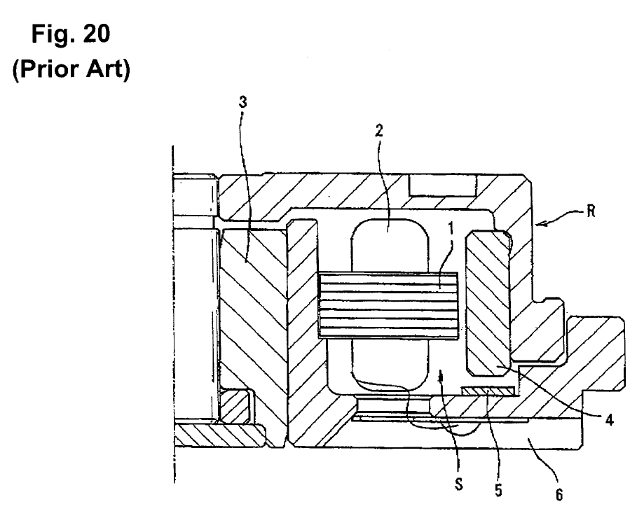

FIG. 19 show a motor in accordance with still another embodiment of the present invention. A radial direction opposing section 157b provided in magnetic attraction plate 157 is formed with a stator core 14 in one piece by a mold forming resin MR, whereby a unitary core molded component MC is composed.

By the structure in accordance with the embodiment shown in FIG. 19, the magnetic attraction plate 157 can be readily and highly accurately fabricated through mold forming.

A variety of embodiments conceived by the present inventors are described above. However, the present invention is not limited to the embodiments described above, and many modifications can be made without departing from the scope of the subject matter of the invention.

For example, in each of the embodiments described above, the present invention is applied to a HDD spindle motor. However, the present invention is also applicable to other spindle motors that are used in a variety of other equipments, as well as spindle motors without dynamic pressure bearing sections.

Also, in each of the embodiments described above, the present invention is applied to an outer rotor type motor in which a stator is disposed inside a rotor. However, the present invention is also applicable to an inner rotor type motor in which a stator is disposed outside a rotor.

As described above, a motor in accordance with the present invention includes a magnetic attraction plate having a generally hollow cylindrical configuration. The magnetic attraction plate is disposed concentrically with a rotor magnet and opposite to a circumferential wall surface of the rotor magnet such that the magnetic flux from the rotor magnet can be effectively used as a magnetic attraction force. As a result, a magnetic attraction force by a magnetic attraction member can be sufficiently obtained with a relatively simple and small structure, and good motor characteristics can be maintained while effectively miniaturizing the motor.

Also, a motor in accordance with the present invention is provided with a magnetic attraction plate having an axial direction opposing section that is disposed opposite to a rotor magnet in the axial direction, as well as a radial direction opposing section that is disposed opposite to the rotor magnet in the radial direction, such that the magnetic flux from the rotor magnet is effectively used as a magnetic attraction force by means of both of the axial direction opposing section and the radial direction opposing section of the magnetic attraction plate, and the positional restriction of the rotor body in the thrust direction can be maintained well without regard to the postures of the rotor body. As a result, a magnetic attraction force by the magnetic attraction plate for the rotor body can be sufficiently obtained with a relatively simple and small structure, and a relatively heavy rotor body in the motor can be rotated very stably with a small spindle motor.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor magnet; and
a magnetic attraction member that is disposed opposite to a circumferential wall surface of the rotor magnet in a radial direction, wherein the magnetic attraction member includes a generally cylindrical member that is disposed concentrically with the rotor magnet.

2. A motor according to claim 1, wherein the magnetic attraction member has a mounting section for mounting the magnetic attraction member on a stator section, wherein the mounting section extends in the radial direction in a flat plate shape in a direction away from the rotor magnet.

3. A motor according to claim 2, wherein the stator section includes a stator core having a plurality of salient poles, and the mounting section extends in a core slot between adjacent ones of the salient poles.

4. A motor according to claim 2, wherein the magnetic attraction member is connected to the mounting section in one piece through a bent section.

5. A motor according to claim 4, wherein the stator section includes a stepped section that is abutted against the bent section of the magnetic attraction member for positioning the magnetic attraction member in place.

6. A motor according to claim 4, wherein the magnetic attraction member and the stator section are formed in one piece with a mold forming resin into a unitary core formed component.

7. A motor according to claim 1, wherein the magnetic attraction member includes an axial direction opposing section that is disposed opposite to an axial end face of the rotor magnet in the axial direction.

8. A motor comprising:
a stator section including a stator core having coils wound on the stator core;
a rotor section that is rotatably supported through a bearing section by the stator section;
a rotor magnet disposed opposite to the stator core; and
a magnetic attraction member that is disposed opposite to a circumferential wall surface of the rotor magnet in a radial direction to magnetically attract the rotor section toward the stator section by a magnetic action between the rotor magnet and the magnetic attraction member, wherein the magnetic attraction member includes a generally cylindrical member that is disposed concentrically with the rotor magnet.

9. A motor according to claim 8, wherein an outer circumferential wall surface of the generally cylindrical member of the magnetic attraction member is disposed opposite to an inner circumferential wall surface of the rotor magnet.

10. A motor according to claim 9, wherein the magnetic attraction member has a mounting section for mounting the magnetic attraction member on the stator section, wherein the mounting section extends in the radial direction in a flat plate shape in a direction away from the rotor magnet.

11. A motor according to claim 10, wherein the stator core includes a plurality of salient poles and coils wound on the salient poles, respectively, and the mounting section of the magnetic attraction member extends in a core slot between adjacent ones of the salient poles.

12. A motor according to claim 10, wherein the stator core includes a plurality of salient poles and coils wound on the salient poles, respectively, the mounting section of the magnetic attraction member includes a plurality of extended sections that extend in core slots between adjacent ones of the salient poles, respectively.

13. A motor according to claim 10, wherein the magnetic attraction member is connected to the mounting section in one piece through a bent section.

14. A motor according to claim 13, wherein the stator section includes a stepped section that is abutted against the bent section of the magnetic attraction member for positioning the magnetic attraction member in place.

15. A motor according to claim 13, wherein the magnetic attraction member and the stator section are formed in one piece with a mold forming resin into a unitary core formed component.

16. A motor according to claim 9, wherein the magnetic attraction member includes an axial direction opposing section that is disposed opposite to an axial end face of the rotor magnet in the axial direction.

17. A motor comprising:
a stator section including a stator core having coils wound on the stator core;
a rotor section that is rotatably supported through a bearing section by the stator section;
a rotor magnet disposed opposite to the stator core; and
a magnetic attraction member that is disposed opposite to a circumferential wall surface of the rotor magnet in a radial direction to magnetically attract the rotor section toward the stator section by a magnetic action between the rotor magnet and the magnetic attraction member,
wherein the magnetic attraction member includes an axial direction opposing section that extends in a direction generally perpendicular to an axial direction and is disposed opposite to the rotor magnet in the axial direction, and a radial direction opposing section that bends generally at right angle from the axial direction opposing section, extends generally in the axial direction and is disposed opposite to the rotor magnet in the radial direction.

18. A motor according to claim 17, wherein an outer circumferential wall surface of the generally cylindrical member of the magnetic attraction member is disposed opposite to an inner circumferential wall surface of the rotor magnet.

19. A motor according to claim 17, wherein the bearing section is composed of a dynamic pressure bearing section that uses dynamic pressure of a lubrication fluid.

20. A motor according to claim 17, wherein the stator core includes a plurality of salient poles and the coils wound on the salient poles, respectively, and the radial direction opposing section of the magnetic attraction member includes a plurality of extended sections that extend in core slots between adjacent ones of the salient poles, respectively.

21. A motor according to claim 17, wherein radial direction opposing section of the magnetic attraction member and the stator core are formed in one piece with a mold forming resin into a unitary core formed component.
